(19) United States
(12) Patent Application Publication
(10) Pub. No.: US 2017/0094940 A1
(43) Pub. Date: Apr. 6, 2017

(54) ANIMAL TOENAIL GRIP

(71) Applicant: Kelly S Leombruno, Cresson, TX (US)

(72) Inventor: Kelly S Leombruno, Cresson, TX (US)

(21) Appl. No.: 14/874,612

(22) Filed: Oct. 5, 2015

(51) Int. Cl. A01K 13/00

(52) U.S. Cl. CPC A01K 13/007

(57) ABSTRACT

An animal toenail grip is provided that provides traction on slippery surfaces for all animals but is of special use to those animals that are unstable due to old age or illness. The toenail grip adds surface area per toenail, which allows additional gripping surface to prevent slipping. The toenail grip engages with the floor at all times without the animal having to engage its toenails. The cylinder shaped grip is constructed of a flexible non-skid/gripping material. The grip is placed over the toenail and affixed using non-toxic adhesive putty. Additional gripping material may externally coat the closed end of the toenail grip.

### BACKGROUND OF THE INVENTION

Field of the Invention

This invention relates to animal toenail/paw grips for purposes of providing traction on slippery surfaces.

Description of the Related Art

Dogs, and other animals with toes, use their toenails to gain traction. When slipping or sliding, dogs flex their paws and engage their toenails to prevent falling. On hard-surface flooring (i.e. wood and tile floors), the engagement of the toenails results in more slippage and causes the animal to lose stability, potentially leading to injuries.

Currently there exist various toenail covers, paw covers, and paw pad adhesives for animals. But most of these are intrusive and uncomfortable for the animals. The paw covers prevent the paws from getting air and thus make the paws hot and uncomfortable. The ring-like toe grips fail to work for all paws especially the ones where the toenails are too short and never touch the floor even when engaged. The prior art fails to disclose a removable flexible cylinder cavity that covers the toenail and extends out past the nail tip to provide constant gripping on all surfaces.

A need exists for toenail caps that are removable and nonintrusive that attach to the nail, whereby such a design provides an animal with traction on slippery and/or hard surfaces. The present invention provides a vehicle to increase the gripping surface area of the toenail and increase friction between the nail tip and the surface of the floor. Therefore, the development of the animal toenail grip of the present invention fulfills the aforementioned need.

Related references include: U.S. Patent No. 2013/0256162 A1 issued in the name of Snyder/Lynd; U.S. Pat. No. 6,786,029 B2 issued in the name of Kuzur; U.S. Pat. No. D329,928 issued in the name of Wexler, U.S. Patent Application No. 2009/0229538 Al published in the name of Friedland; U.S. Pat. No. 4,962,731 issued in the name of Wexler, U.S. Pat. No. D564,713 issued in the name of Wexler, U.S. Pat. No. D560,317 issued in the name of Townsend; U.S. Pat. No. 7,703,419 Bl issued in the name of Wexler, U.S. Pat. No. 7,069,879 B1 issued in the name of Wexler, U.S. Pat. No. 6,863,033 B1 issued in the name of Fleming; and U.S. Patent Application No. 2007/0089691 A1 published in the name of Hendy.

Other objects and advantages will be more fully apparent from the following disclosure and appended claims.

### SUMMARY OF THE INVENTION

The invention herein is an animal toenail grip that provides traction on slippery surfaces for all animals but is of special use to those animals that are unstable due to old age or illness or after surgery. The toenail grip adds surface area per toenail, which allows additional gripping surface to prevent slipping. The toenail grip engages with the floor at all times without the animal having to engage its toenails. The cylinder shaped grip is constructed of a flexible non-skid/gripping material. The grip is placed over the toenail and affixed using non-toxic adhesive putty. The closed end of the toenail grip may be externally coated with extra gripping material.

Other objects and features of the inventions will be more fully apparent from the following disclosure and appended claims.

### BRIEF DESCRIPTION OF THE DRAWINGS

FIG. 1 is a side view of a dog's paw showing the toenail configuration in reference to the floor. The dog's paw is shown in reference to the floor where the toenail is not engaged with the floor thus allowing the animal to slip and loose traction when the toenail grip of the invention is not used.

FIG. 2 is a side view of a dog's paw showing the toenail configuration in reference to the floor with the toenail grip present. The dog's paw is shown in reference to the floor where the toenail on the dog is engaged via the toenail grip engaging with the floor allowing the animal to always maintain traction.

FIG. 3 is a perspective view of a toenail grip of the invention herein.

FIG. 4 is a perspective view of a tab of adhesive putty rolled for placement in a toenail grip of the invention herein.

FIG. 5 is a perspective view of an open end of a toenail grip into which adhesive putty has been inserted.

FIG. 6 is a perspective view of the toenail grip of the invention coated with extra gripping material.

### DETAILED DESCRIPTION OF THE INVENTION AND PREFERRED EMBODIMENTS THEREOF

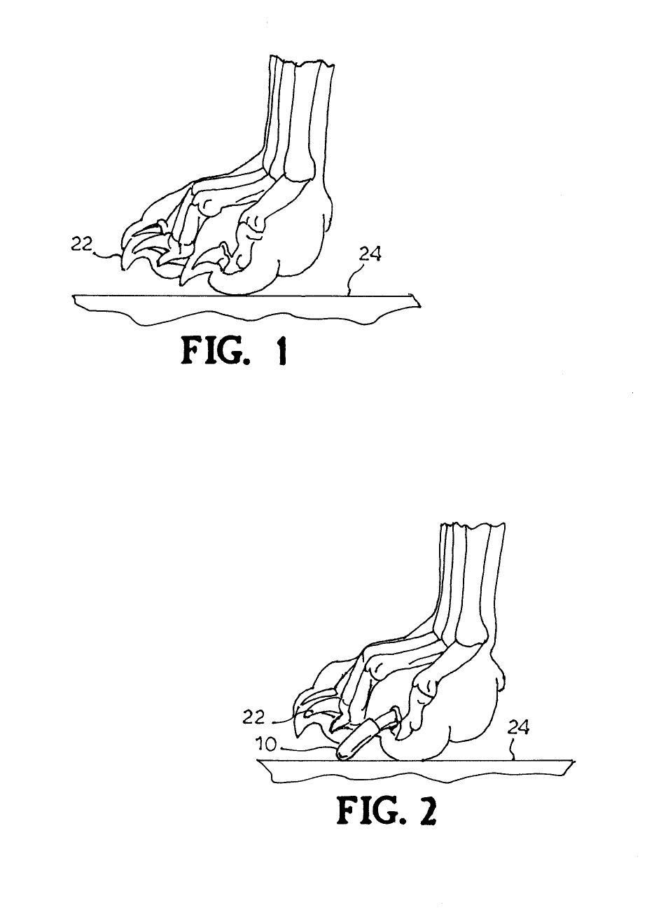

The present invention is a toenail cap or covering, herein called a toenail grip 10, which is designed and configured to provide an animal such as a dog with traction on a slippery floor surface or other surface 24 on which the animal is to stand or walk or run (FIGS. 1-3).

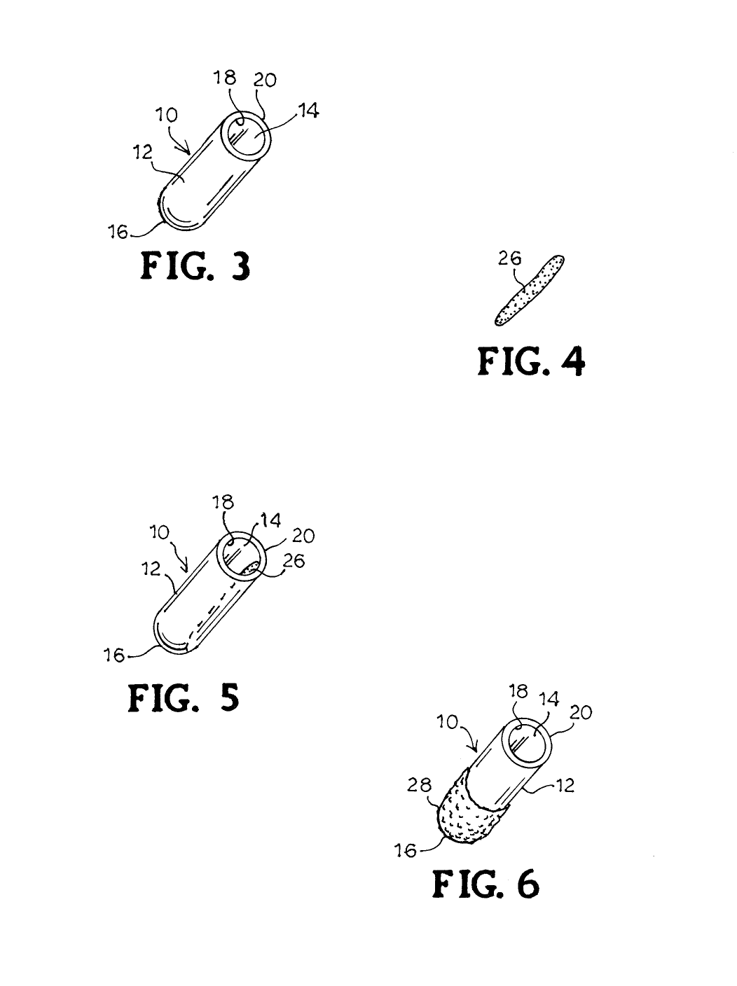

The toenail grip 10 of the invention herein comprises an elongated cylinder 12 and is held on the animal's toenail with a flexible adhesive putty 26. The toenail grip 10 has an open end 14 that is circular in cross-section, a rounded closed end 16 and a central cylindrical inner cavity 18 (FIG. 3). The cylindrical wall 20 around and at the rounded closed end 16 of the cavity 18 is preferably of the same thickness on the whole toenail grip 10, preferably about 0.02 inch thick for a very small toenail grip 10 to about 0.06 inch thick for a very large toenail trip 10. The closed end 16 of the toenail cap is preferably rounded as shown in FIG. 2 and does not end in a pointed tip or otherwise closely sheathe the end of the animal's toenail. The central cylindrical inner cavity 18 extends throughout the length of the cylinder 12. The cylinder 12 is equal in diameter from the open end 14 to the closed end 16 (in other words, it is not tapered) and provides a large gripping surface area on the closed end 16, which is in contact with the surface 24 upon which the animal is standing, walking or running.

In particular, the toenail grip 10 of the invention herein is a cylinder of a length that is related to the length of the dog's toenail 22. Preferably the toenail grip 10 extends at least about ½ to ¾ of the distance from the tip of the nail to the base (hairline) of the nail. It needs to be longer than just covering the tip of the nail so that it does not easily come off of the nail, and it should not extend all of the way to the hairline. Thus, to determine which size of toenail grip 10 is best for use for a particular dog, one determines the toenail length and circumference of the toenail about halfway from the tip of the toenail to the base (hairline) of the toenail. Once the circumference is determined for a particular dog, the appropriate diameter toenail grip 10 can be determined. If the selected size (circumference/diameter) toenail grip 10 is too long for a particular dog, the length can be cut to fit.

Examples of useful sizes of toenail grips for dogs are shown in Table 1:

TABLE 1

| | Dimensions of Grip | Approximate amount |
|---|---|---|
| Size of | (diameter × outer | of Putty |
| Toenail Grip | length, inches) | (LOCTITE ™ tab) |
| X Large | ⅜ × ⅝ | ½ tab |
| Large | 5/16 × ⅝ | ⅓ tab |
| Medium | ¼ × ½ | ¼ tab |
| Small | 3/16 × ⅜ | ⅕ tab |
| Very Small | 5/32 × ⅜ | ⅙ tab |

The toenail grip 10 of the invention is constructed of a flexible resilient nontoxic nonskid material, such as vinyl or natural rubber/latex. In use, the toenail grip cylinder 12 extends over the animal's toenail 22 so that the closed end 16 of the toenail grip 10 and about half of the portion of the toenail grip 10 that is on the bottom of the dog's toenail are in contact with the floor surface 24 at all times when the dog's foot is on the surface 24. This allows the animal to maintain traction on a surface 24 at all times and without having to engage the toenails.

The toenail grip 10 made of such materials thus has a gripping outer surface due to the non-slippery nature of the material used. To enhance the gripping nature of the toenail grip 10, an external portion of the closed end 16 of the toenail grip 10 may be manufactured as known in the art with an additional extra gripping material 28, as is used on non-skid socks, externally coating the closed end 6 and extending about halfway down the length of the toenail grip 10 (FIG. 6).

In use, the central cylindrical inner cavity 18 f the toenail grip 10 is slipped over the toenail 22 of the animal, and easily held in p ce on the toenail via flexible adhesive putty 26 that is inserted into the toenail grip 10 before slipping the toenail grip 10 over the toenail 22. A preferred putty material 26 is provided by LOCTITE™ FUN-TAK MOUNTING TABS™ non-toxic putty. These tabs are approximately ½x ¼ inch in size. Alternatively, an appropriately sized portion of a flexible adhesive stick provided by the same manufacturer may be used, or similar mounting putty sticks and tables of other manufacturers may be used. The desired amount of putty material is cut from the tabs (see Table 1 above), formed into an elongated piece, preferably by rolling it into a narrow cylinder of putty 26 until it is approximately as long as the interior length of the toenail grip (FIG. 4) and preferably fills about ¼ to ⅓ of the inner cavity 18. The narrow piece of putty 26 is then inserted into the open end 14 of the toenail grip 10 so that it extends the interior length of the toenail grip 10 (FIG. 5). The toenail grip 10 is then placed on the animal's toenail. Twisting the toenail grip 10 helps to spread and distribute the putty 26 around the toenail. So long as the putty 26 sticks the toenail to the toenail grip 10, it does not matter where the putty 26 is within the toenail grip 10.

Once placed on the toenail 22, as the animal walks or runs, the bottom/base of the toenail grip 10 engages the surface 24 on which the animal is walking or running and grips such surface 24 thereby providing the animal with constant traction. While not necessary to put toenail grips 10 on all of the animal's toes, the animal's footing on floor surfaces is improved if additional toenail grips 10 are used. For a more stable animal, a toenail grip 10 placed on a single toenail on each foot, preferably the innermost or outermost toenail 10 can be sufficient. For less stable animals, a toenail grip 10 can be placed on both the outermost and innermost toenails of each foot. Toenail grips 10 can be placed on just the rear feet or on all feet of the animal.

The toenail grip 10 is removable from the animal toenail 22. Because the putty 26 sticks firmly to the animal's toenail 22, it is useful to cut the toenail grip 10 carefully (for example with a manicure scissors) lengthwise down the side and peel it off the toenail 22.

The benefits of the current invention include the following:
To provide stability and confidence for the geriatric/unstable animal by helping it gain better traction on hard-surface flooring, preventing legs from spreading, assisting in standing, walking and running without slipping on a hard or slippery surface.
To improve the stability of animals while standing on and/or moving across hard-surface flooring or other slippery surfaces.
To reduce the likelihood of slip-and-fall injury to the animal.
To reduce or eliminate the emotional stress an animal experiences from slipping on hard-surface flooring or other slippery surfaces, thereby also reducing slipping fear related behaviors.
To improve an animal's quality of life by providing confidence, stability, mobility and increased activity level.

While the invention herein is designed particularly for use with dogs, it is within the invention herein for the toenail grips of the invention to be resized appropriately for use on other animals with nonretractible claws if there is a problem with them slipping on surfaces.

While the invention has been described with reference to specific embodiments, it will be appreciated that numerous variations, modifications, and embodiments are possible, and accordingly, all such variations, modifications, and embodiments are to be regarded as being within the spirit and scope of the invention.

What is claimed is:

1. An animal toenail grip, comprising:
(a) a cylinder constructed of flexible resilient material with a gripping outer surface and a central cavity extending throughout the length of the cylinder, said cavity having an open end and a closed end; wherein the cylinder is equal in diameter from the open end to the closed end and provides a gripping surface area on the closed end, and is sized to fit over the animal toenail; and.
(b) a non-toxic adhesive putty placed in the inner cavity to affix the cylinder to a toenail of the animal.

2. The toenail grip of claim 1, wherein the putty is rolled into a narrow cylinder before placement in the cylinder.

3. The toenail grip of claim 1, further comprising additional gripping material externally coating the closed end of the cylinder.

4. A toenail grip for an animal, comprising:
(a) a flexible resilient cylinder having a central cylindrical inner cavity, a closed end and an open end, which open end slides onto a toenail of an animal; and
(b) a non-toxic adhesive putty placed in the inner cavity to affix the cylinder to a toenail of the animal, wherein the cylinder has a gripping outer surface, and wherein the cylinder is of the same diameter from the open end of the cylinder to the closed end of cylinder.

5. The toenail grip of claim 4, wherein the putty is rolled into a narrow cylinder before placement in the flexible resilient cylinder.

6. The toenail grip of claim 4, further comprising additional gripping material externally coating the closed end of the flexible resilient cylinder.

7. A method of improving traction for an animal with toenails, comprising:
a) providing a cylinder according to claim 1 that is of a size to fit the animal's toenail length and width;
b) providing an elongated piece of a non-toxic adhesive putty;
c) inserting the narrow cylinder of non-toxic adhesive putty into the central cylindrical inner cavity of the flexible resilient cylinder; and
d) removably placing the flexible resilient cylinder and non-toxic adhesive putty over an animal toenail.

8. The method of claim 7, wherein the cylinder further comprises additional gripping material externally coating the closed end of the cylinder.
